(19) United States
(12) Patent Application Publication
(10) Pub. No.: US 2008/0164396 A1
(43) Pub. Date: Jul. 10, 2008

(54) Clamping Mechanism

(75) Inventor: Hui Chen, Burlingame, CA (US)

Correspondence Address: FISH & RICHARDSON P.C., P.O. BOX 1022, MINNEAPOLIS, MN, 55440-1022, US

(73) Assignee: Applied Materials, Inc.

(21) Appl. No.: 11/621,937

(22) Filed: Jan. 10, 2007

(51) Int. Cl. B25B 5/10

(52) U.S. Cl. 248/316.5

(57) ABSTRACT

A clamp for holding two cylindrical devices together is described.

### BACKGROUND

The present invention relates to clamps for joining together components. Processing applications for semiconductor materials can include polishing, depositing, etching, doping, reacting and other such techniques. Processing equipment used to perform one or more of these techniques can include parts that require maintenance, such as cleaning and repair. Therefore, the processing equipment often includes multiple parts that can be taken apart and put back together again once the maintenance has been performed. A useful component of processing equipment is a clamping mechanism for holding two or more components together. As indicated by its name, a clamping mechanism functions by pressing and holding together the two components.

### SUMMARY

In one aspect, a clamp is described. The clamp has a resilient strip in a curved configuration, two or more clamping blocks fastened to the flexible strip, an end clamping block and a fastener connected to the end clamping block. The strip curves along at least one half of a circle and forms an arc with a concave interior and a convex exterior. The clamping blocks are along the interior of the arc formed by the strip. The end clamping block is pivotally connected to one clamping block of the two or more clamping blocks. The fastener connects to a clamping block to cause the clamp to form an annular configuration.

Implementations of the clamp may include one or more of the following features. The end clamping block can be prevented from pivoting when the clamp is open to form an angle of less than 90° with the clamping block to which the end clamping block is pivotally attached. The clamp may include a receiving block, the receiving block configured to receive the fastener. The receiving block can be pivotally attached to one of the two or more clamping blocks that the end clamping block is not pivotally attached to. The receiving block can be prevented from pivoting when the clamp is open to form an angle of less than 90° with the clamping block to which the receiving block is pivotally attached. The fastener can include a screw swing shaft. The fastener can include a deformable washer. The clamping blocks can be fastened to the resilient strip with rivets. The resilient strip can have at least three clamping blocks riveted thereto. When the clamp in the annular position and the fastener is fastened, the clamp can be in a closed position and when the clamp in an open position and not under externally applied force, the clamping blocks may not lie in a straight line with one another. Each of the clamping blocks can have an upper extension and a lower extension with a recess between the upper extension and the lower extension, when the clamp is the closed position, the upper extension and the lower extension of the clamping blocks may form an inner diameter of the clamp. Each of the clamping blocks may be curved. The clamping blocks fastened to the resilient strip can be spaced equidistantly apart along the strip. At least one link plate can connect the end clamping block to the one clamping block of the two or more clamping blocks. The fastener can include a screw. The fastener can include a lock nut. The lock nut can be formed of stainless steel. The resilient strip can be formed of stainless steel. The fastener can include a threaded shaft and a wing nut. The clamping blocks can include aluminum or an aluminum alloy.

Embodiments of the clamping mechanisms described herein can include one or more of the following. The clamping mechanism may be prevented from being opened more than a predetermined amount. Therefore, the clamping mechanism may be closed and fastened by a user with a single hand. With clamping mechanisms having an attached fastener, the fastener cannot be separated from the clamping mechanism and thus cannot be dropped from the clamping mechanism. This may prevent the loss of the fastener and facilitate the tightening of the fastener while the components being fastened together are held in place. Clamping blocks spaced evenly around the clamping mechanism can allow for even distribution of pressure around the circumference of the clamping mechanism. Even distribution of pressure can prevent damage to the components that are clamped together. The clamping mechanisms described herein can reduce leaks, jolts and vibrations between the two components that are connected together. The clamping mechanism can few moving parts, which reduces the likelihood of particle generation during clamp use. If fewer particles are generated by the clamp, the processing environment can be kept cleaner. Therefore, the processing yield may be higher, due to fewer contaminated processed parts. The components can be formed from corrosion resistant material, which can lead to a long life span for the clamping mechanism. The clamping mechanism may be used with a variety of processing systems, such as vacuum apparatuses, etchers and polishers.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a perspective view of one implementation of a clamp.

FIG. 2 is a perspective view of the clamp in FIG. 1 in an open position.

FIG. 3 is a side view of a clamp fastening together two components of a polishing apparatus.

FIG. 4 is a cross-sectional view of a clamp fastening together two components of a polishing apparatus.

Like reference symbols in the various drawings indicate like elements.

### DETAILED DESCRIPTION

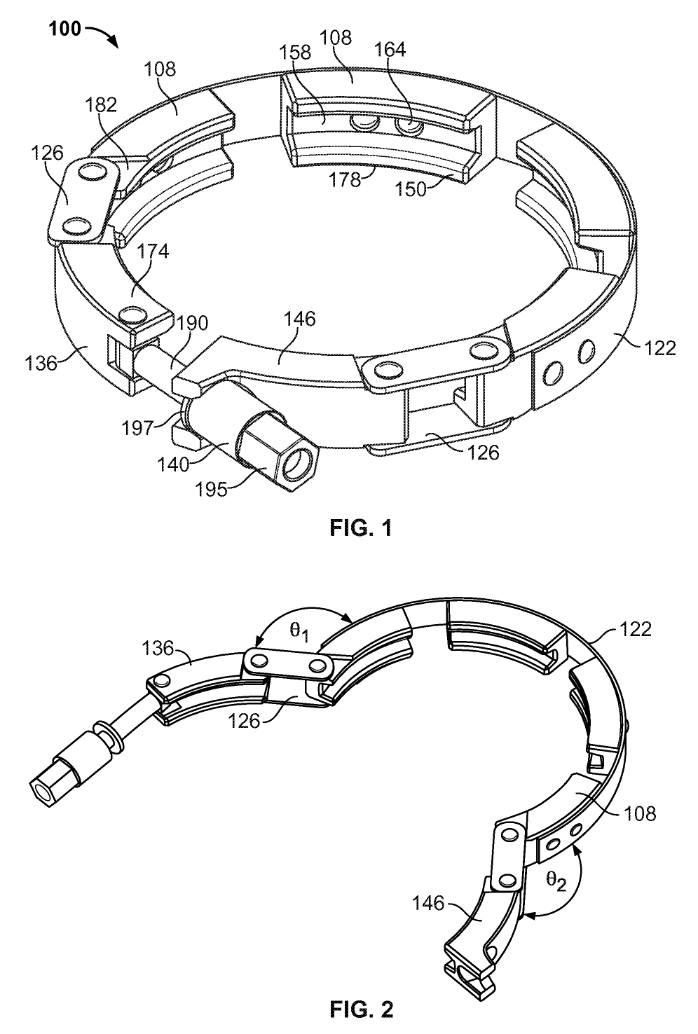

Referring to FIG. 1, a clamping mechanism 100 is configured to fasten together two cylindrical bodies. The clamping mechanism 100 has one or more clamping blocks 108 for contacting the cylindrical bodies to be joined together. The clamping blocks 108 are fastened to a spring strip 122. One of the clamping blocks is flexibly or pivotally connected to a fastener base 136. The fastener base 136 is also pivotally connected to a fastener 140. The fastener 140 fits into a fastener receiver 146, which is also pivotally connected to a clamping block 108, when the clamping mechanism is in a closed position. The fastener receiver 146 and fastener base 136 can be generally adjacent, but at opposite ends of the unfastened or open clamping mechanism 100, e.g., the fastener base 136 can be connected to a clamping block at one end of the spring strip 122 and the fastener receiver 146 can be connected to a clamping block at the other end of the spring strip 122.

The spring strip 122 is a curved, thin strip of material. In some implementations, the spring strip 122 is formed from a metal, such as stainless steel, for example, grade 301 stainless steel that has been tempered. The spring strip 122 is preformed into its curved shape, which follows at least a portion of an approximately annular shape. The spring strip 122 is thin enough to be flexible, allowing the spring strip 122 to bend. In some implementations, the spring strip 122 is sufficiently resilient so that bending the spring strip 122 is not likely to permanently deform the spring strip 122. When the clamping mechanism 100 is closed, the spring strip 122 distributes the force of the clamping mechanism 100 evenly. The spring strip 122 can have a width that is about equal to the height of the clamping blocks 108, or the spring strip can be narrower or wider than the height of the clamping blocks 108. In some implementations, the spring strip is long enough to form at least a half circle around the cylinders that are to be clamped together. The spring string can be even longer, reaching as far as three-quarters of the way around the circumference of a circle when in an open or a relaxed position.

Attached to the spring strip 122 are two, three, four, five or more clamping blocks 108. A clamping block 108 can be formed of a material that does not deform or resists breaking when under pressure, such as metal, for example, aluminum or stainless steel, for example grade 304 stainless steel. Each clamping block 108 is positioned along the concave portion, e.g., the interior surface, of the spring strip 122. The clamping block 108 can have a generally curved shape with a backside having a convex shape and a front side having a concave shape. The backside is adjacent to the spring step 122. In some implementations, the clamping blocks 108 are equally spaced from one another along the strip 122. In some implementations, the front surface, or inner surface 150, has a recess 158 configured to receive a flange of the cylinders that are clamped together. In some embodiments, a compliant material is in the recess, such as a plastic or a hard rubber. In some embodiments, the clamping blocks have a frontside that has a smooth continuous surface that is free of any recess.

The clamping blocks 108 are fastened to the spring strip 122, such as with an adhesive, bolts, tacks, screws, staples, welds or rivets 164 or other suitable fastening device. If the fastening device extends through the clamping block 108 to the inner surface 150 of the clamping block 108, the fastening device can be flush with the inner surface 150 to avoid obstructing the clamping block 108.

As noted above, the fastener base 136 is connected to a clamping block 108 at the end of the spring strip 122. The clamping block 108 that is connected to the fastener base 136 can be connected by a pivoting mechanism, such as a link plate 126 connected by fasteners that allow the link plate to rotate, such as a rivet 170. Link plates 126 can be placed on the top surface 174 and the bottom surface 178 of the clamping block 108. The rotation of the link plate 126 can be limited. In some implementations, the top surface 174 of the clamping block 108 to which the fastener base 136 is attached has a depression 182 on one end. The link clamp 126 is connected to the clamping block 108 in the depression 182 area. The extent of the depression 182 prevents the fastener base 136 from rotating beyond a predetermined angle. In some embodiments, the edge of the depression 182 stops a link plate from pivoting so the fastener base 136 forms greater than a 90° with the clamping block to which it is attached when the clamp is open, as shown in FIG. 2. In other embodiments, the fastener base 136 is prevented from pivoting to an open position forming an angle θ₁ of less than 100°, less than 115°, less than 135° or less than 180° with the closest clamping block 108.

Similarly, the fastener receiver 146 can be limited in its ability to pivot open. In some embodiments, the fastener receiver 146 is prevented from pivoting open to an open position to form an angle θ₂ of less than 90°, less than 100°, less than 115°, less than 135° or less than 180° with the closest clamping block 108.

The fastener 140 can either be pivotally connected to the fastener base 136, or can be stationary with respect to the fastener base 136. The fastener can include a screw swing shaft 190, which includes a lock nut 195. In other embodiments, instead of a screw swing shaft 190, a threaded shaft with a wing nut is used. However, a screw swing shaft 190 prevents the fastener from being dropped by the user. The screw swing shaft 190 can be formed of a stainless steel, such as 300 series stainless steel. The nut can be made of a metal, such as stainless steel, for example stainless steel nitronic or A286. In embodiments, the screw swing shaft 190 and nut are formed of different materials to prevent gouging. In some embodiments, a washer 197 of a deformable material, such as plastic, for example polyetheretherketone (PEEK) or nylon, fits between the nut and fastener receiver 146. A compliant washer 197 prevents particles from being formed when the nut is tightened in place. In some embodiments, the fastener receiver 146 has a housing that has dimensions that correspond to those of the washer. That is, the fastener receiver 146 can from a housing that extends in an L-shape, where the extension has a neck. The neck can have an opening that is similar in radius to the diameter of the hole in the washer. When the nut is tightened, the washer seats into a recess in the housing, that is, in the neck. Even pressure is placed on the washer, which prevents the washer from being deformed. Of course, some portion of the washer is not supported by the housing, that is, the portion that corresponds to the opening in the neck where the screw swing shaft enters the fastener base 136.

The fastener base 136 can be similarly shaped to the clamping blocks 108. That is, the fastener base 136 can have a curved profile with a concave side and a convex side. The fastener base 136 can have a recess along its concave side. Similarly, the fastener receiver can have a curved profile.

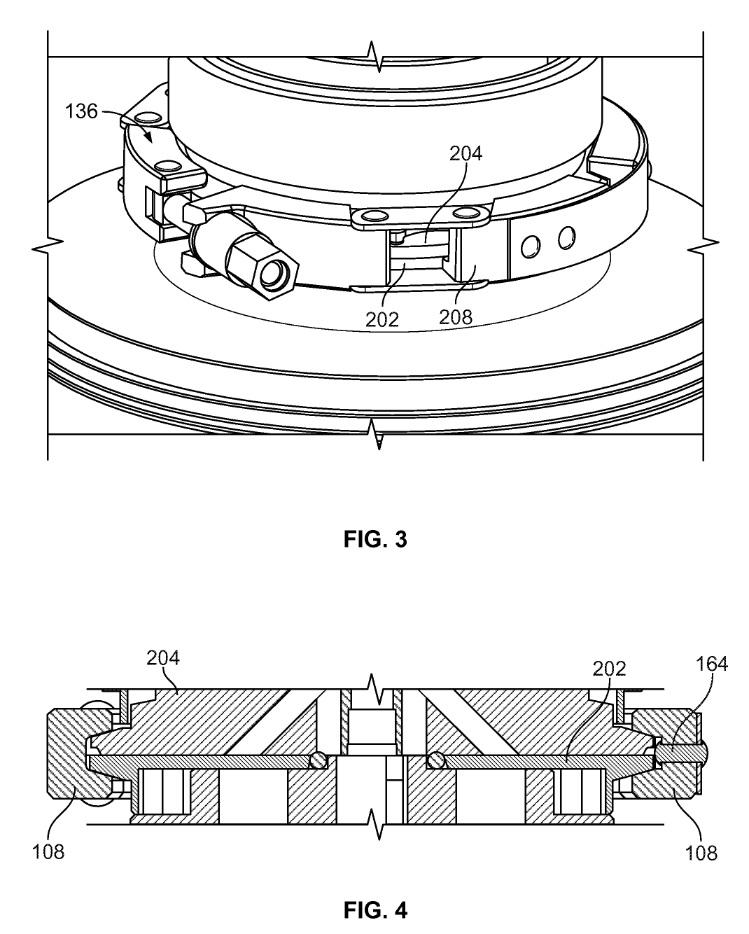

Referring to FIGS. 3-4, the clamp described herein is useful for clamping together a head and a spindle of a chemical mechanical polishing apparatus (CMP), such as the one described in U.S. Pat. No. 7,089,782, “Polishing Head Test Station”. The clamp can be used for a variety of other purposes, including, but not limited to vacuum apparatuses, such as sputtering devices, plasma etchers, chemical vapor deposition chambers, or other applications that require a clamp that can tolerate high torque or high force environments. In a CMP device, the head flange 202 and the spindle flange 204 fit into the recess formed in the clamping blocks 108. The clamp opens and closes easily with one hand, which is advantageous when the parts must be taken apart and put back together frequently, such as weekly or even daily. Using four clamping blocks, rather than two or three, can reduce leaks, jolting and vibration during spinning, moving or operation of the clamped parts.

The clamping mechanism can be used as follows. A user opens the clamping mechanism to be in the open position, such as is shown in FIG. 2. With one hand, the user can hold the two components that are to be clamped together in place. With the other hand, the user can align the clamping mechanism with the intersection of the two components and push the clamping mechanism onto the two components. With a slight amount of force from the user, the spring strip bends, if necessary, to fit around the widest part of the components. Once past the widest part of the components, the spring strip snaps the clamping blocks into place. If the user now releases the clamping mechanism, the clamping mechanism stays in place. The user then pivots the fastener receiver into a closed position, if the fastener receiver is pivotable. Next, the user pivots the fastener base closed. If the fastener is separately pivotable, the fastener is moved into place, so that it is in the fastener receiver. The fastener is then tightened. The user can now release the components, because the clamping mechanism holds them together.

Because the spring strip distributes the clamping force evenly around the two objects being clamped together, the clamp is easier to remove when the fastener is released. Additionally, the even distribution of pressure reduces the likelihood of jamming the objects being clamped together and the clamp. The force prevents the clamps from sliding when the clamps do not have a recess to engage the bodies that that they clamp together. The pre-formed spring strip provides a spring force to hold the clamping blocks close enough to a circular shape that the fastener and the fastener receiver are easily brought together when the clamp is to be closed. Because of machining tolerances, not all of the clamping blocks have precisely the same dimensions. The spring strip can equalize the differences of force applied by each of the clamping blocks. The optional swing stop feature limits the swing of fastener and the fastener receiver. If the clamp is prevented from opening too much, the clamp user can apply and close the clamp using a single hand. This frees up the user's other hand for holding the pieces that are to be locked together in place.

The materials that are described herein for forming the pieces of the clamp provide corrosion resistance and prevent the fastener from gall. However, other materials with suitable durability and resistance to corrosion in environments in which chemicals are in use can be used.

A number of embodiments of the invention have been described. Nevertheless, it will be understood that various modifications may be made without departing from the spirit and scope of the invention. For example, the clamp can be made to fit around objects that are not cylindrical, but oval, rectangular or other shapes. Accordingly, other embodiments are within the scope of the following claims.

What is claimed is:

1. A clamp, comprising:
a resilient strip in a curved configuration, wherein the strip curves along at least one half of a circle;
two or more clamping blocks fastened to the flexible strip, wherein the strip forms an arc with a concave interior and a convex exterior and the clamping blocks are along the interior of the arc formed by the strip;
an end clamping block pivotally connected to one clamping block of the two or more clamping blocks; and
a fastener connected to the end clamping block, wherein the fastener connects to a clamping block to cause the clamp to form an annular configuration.

2. The clamp of claim 1, wherein the end clamping block is prevented from pivoting when the clamp is open to form an angle of less than 90° with the clamping block to which the end clamping block is pivotally attached.

3. The clamp of claim 1, further comprising a receiving block, the receiving block configured to receive the fastener.

4. The clamp of claim 3, wherein the receiving block is pivotally attached to one of the two or more clamping blocks that the end clamping block is not pivotally attached to.

5. The clamp of claim 4, wherein the receiving block is prevented from pivoting when the clamp is open to form an angle of less than 90° with the clamping block to which the receiving block is pivotally attached.

6. The clamp of claim 1, wherein the fastener includes a screw swing shaft.

7. The claim of claim 1, wherein the fastener includes a deformable washer.

8. The clamp of claim 1, wherein the clamping blocks are fastened to the resilient strip with rivets.

9. The clamp of claim 1, wherein the resilient strip has at least three clamping blocks riveted thereto.

10. The clamp of claim 1, wherein:
when the clamp is in the annular position and the fastener is fastened, the clamp is in a closed position; and
when the clamp in an open position and not under externally applied force, the clamping blocks do not lie in a straight line with one another.

11. The clamp of claim 10, wherein each of the clamping blocks has an upper extension and a lower extension with a recess between the upper extension and the lower extension and when the clamp is the closed position, the upper extension and the lower extension of the clamping blocks form an inner diameter of the clamp.

12. The clamp of claim 1, wherein each of the clamping blocks is curved.

13. The clamp of claim 1, wherein the clamping blocks fastened to the resilient strip are spaced equidistantly apart along the strip.

14. The clamp of claim 1, wherein at least one link plate connects the end clamping block to the one clamping block of the two or more clamping blocks.

15. The clamp of claim 1, wherein the fastener includes a screw.

16. The clamp of claim 1, wherein the fastener includes a lock nut.

17. The clamp of claim 16, wherein the lock nut is formed of stainless steel.

18. The clamp of claim 1, wherein the resilient strip is formed of stainless steel.

19. The clamp of claim 1, wherein the fastener includes a threaded shaft and a wing nut.

20. The clamp of claim 1, clamping blocks include aluminum or an aluminum alloy.
